(19) United States
(12) Patent Application Publication
(10) Pub. No.: US 2010/0068441 A1
(43) Pub. Date: Mar. 18, 2010

(54) EASY-TO-STRAIGHT-TEAR PLASTIC FILM, AND ITS PRODUCTION METHOD AND APPARATUS

(75) Inventor: Seiji Kagawa, Koshigaya-shi (JP)

Correspondence Address: SUGHRUE MION, PLLC, 2100 PENNSYLVANIA AVENUE, N.W., SUITE 800, WASHINGTON, DC, 20037, US

(73) Assignee: Seiji Kagawa, Koshigaya-shi, Saitama-ken (JP)

(21) Appl. No.: 12/594,506

(22) PCT Filed: Apr. 2, 2008
(86) PCT No.: PCT/JP2008/056613

§ 371 Date: Oct. 2, 2009

(30) Foreign Application Priority Data
Apr. 2, 2007 (JP) 2007-096880

(51) Int. Cl. B32B 3/24; B26D 1/02

(52) U.S. Cl. 428/43; 83/23; 83/509

(57) ABSTRACT

An apparatus for producing a long, easy-to-straight-tear plastic film having large numbers of substantially parallel half-cut lines extending in a transverse direction on at least one surface, comprising (a) a roll having at least one cam axially extending on a circular surface of said roll, and (b) a cutter arranged in parallel to said roll with a gap narrower than the thickness of said plastic film, the rotation of said roll causing said cam to intermittently push said plastic film to said cutter to form half-cut lines on said plastic film.

### FIELD OF THE INVENTION

The present invention relates to a plastic film having excellent straight tearability, and a method and an apparatus for producing such an easy-to-straight-tear plastic film at low cost without generating dust, particularly to a plastic film having straight tearability in a width direction and its production method and apparatus.

### BACKGROUND OF THE INVENTION

Various easy-to-open wrapping bags have been developed so far. For instance, JP 5-42951 A proposes an easy-to-open bag provided with linear dents in heat-sealing edge portions. As shown in FIG. 10, the dents are formed by passing heat-sealing portions of a plastic film 100 between a vibrating ultrasonic hone 200 and a roll 300 having a linear grooves on a circular surface. However, dents formed by the plastic deformation of the plastic film 100 by the roll 300 do not have sufficient tearability.

WO2003/091003 discloses a method for forming parallel linear scratches on a plastic film by bringing a roll having large numbers of fine projections on a circular surface into sliding contact with the plastic film under pressure. The plastic film provided with linear scratches can be torn straight from an arbitrary position. However, this production method suffers the generation of dust.

### OBJECTS OF THE INVENTION

Accordingly, an object of the present invention is to provide a plastic film having excellent straight tearability.

Another object of the present invention is to provide a method and an apparatus for producing such an easy-to-straight-tear plastic film at low cost without generating dust.

### DISCLOSURE OF THE INVENTION

As a result of intensive research in view of the above objects, the inventor has found that (a) by arranging a roll having a cam axially extending on a circular surface and a cutter arranged in parallel to said roll with a gap narrower than the thickness of a plastic film, and by passing the plastic film between them with the cam nearing said cutter intermittently by the rotation of said roll, parallel half-cut lines can be formed on the plastic film without dust, and that (b) a plastic film thus provided with half-cut lines has excellent straight tearability. The present invention has been completed based on such finding.

Thus, the long, easy-to-straight-tear plastic film of the present invention has large numbers of substantially parallel half-cut lines extending in a transverse direction on at least one surface.

Said half-cut lines are preferably formed over the entire surface, such that the plastic film can be torn substantially straight from an arbitrary position. To secure sufficient straight tearability, the depth of said half-cut lines is preferably 10-50% of the thickness of the plastic film.

The method of the present invention for producing a long, easy-to-straight-tear plastic film having large numbers of substantially parallel half-cut lines extending in a transverse direction on at least one surface comprises the steps of (1) arranging a roll having at least one cam axially extending on a circular surface of said roll, and a cutter parallel to said roll with a gap narrower than the thickness of said plastic film, (2) moving said plastic film between said roll and said cutter in a direction perpendicular to the axial direction of said roll, and (3) rotating said roll, so that said cam intermittently pushes said plastic film to said cutter, to form half-cut lines on said plastic film.

A gap between said cam and said cutter is preferably 10-50% of the thickness of said plastic film. Said half-cut lines are preferably formed on an entire surface of said plastic film. The peripheral speed of said roll is preferably 10-50 times the moving speed of said plastic film.

The apparatus of the present invention for producing a long, easy-to-straight-tear plastic film having large numbers of substantially parallel half-cut lines extending in a transverse direction on at least one surface comprises (a) a roll having at least one cam axially extending on a circular surface of said roll, and (b) a cutter arranged in parallel to said roll with a gap narrower than the thickness of said plastic film, the rotation of said roll causing said cam to intermittently push said plastic film to said cutter to form half-cut lines on said plastic film.

Said roll preferably has pluralities of cams with substantially equal intervals. A gap between said cam and said cutter is preferably 10-50% of the thickness of said plastic film.

It is preferable that a holder of said cutter is fixed to a resilient plate mounted to a frame of the apparatus, and that said roll engages pluralities of actuators fixed to said frame. When said actuators are preferably operated to press said holder, said resilient plate is resiliently deformed by a pressing force to finely adjust the position of said cutter fixed to said holder, such that a gap between said cam and said cutter is substantially uniform over the entire width of said plastic film. Said resilient plate preferably has a resiliently deformable thin portion.

### BRIEF DESCRIPTION OF THE DRAWINGS

FIG. 1(a) is a schematic cross-sectional view showing a plastic film before pressed by a cam of a roll.

FIG. 1(b) is a schematic cross-sectional view showing a plastic film pressed by a cam of a roll to come to contact with a cutter.

FIG. 1(c) is a schematic cross-sectional view showing a cam of a roll at the closest position to a cutter to form a half-cut line on a plastic film.

FIG. 1(d) is a schematic cross-sectional view showing a cam of a roll moving away from a cutter, so that a plastic film is separated from a cutter.

FIG. 2 is a schematic cross-sectional view showing the apparatus of the present invention for producing an easy-to-straight-tear plastic film.

FIG. 3 is a partially enlarged cross-sectional view showing a roll and a cutter.

FIG. 4 is a partially enlarged exploded view showing a mechanism of mounting a cam to a roll.

FIG. 5 is a partially enlarged exploded view showing a mechanism of mounting a cutter to a holder.

FIG. 6 is a schematic view showing an apparatus for producing an easy-to-straight-tear plastic film according to one embodiment of the present invention.

FIG. 7 is a schematic view showing the relation between a roll and a cutter.

FIG. 8 is a perspective view showing the formation of half-cut lines to a plastic film.

FIG. 9 is a schematic view showing an apparatus for producing an easy-to-straight-tear plastic film according to another embodiment of the present invention.

FIG. 10 is a schematic view showing a conventional apparatus for producing a wrapping film.

### DESCRIPTION OF THE PREFERRED EMBODIMENTS

[1] Method and Apparatus for Producing Easy-To-Straight-Tear Plastic Film

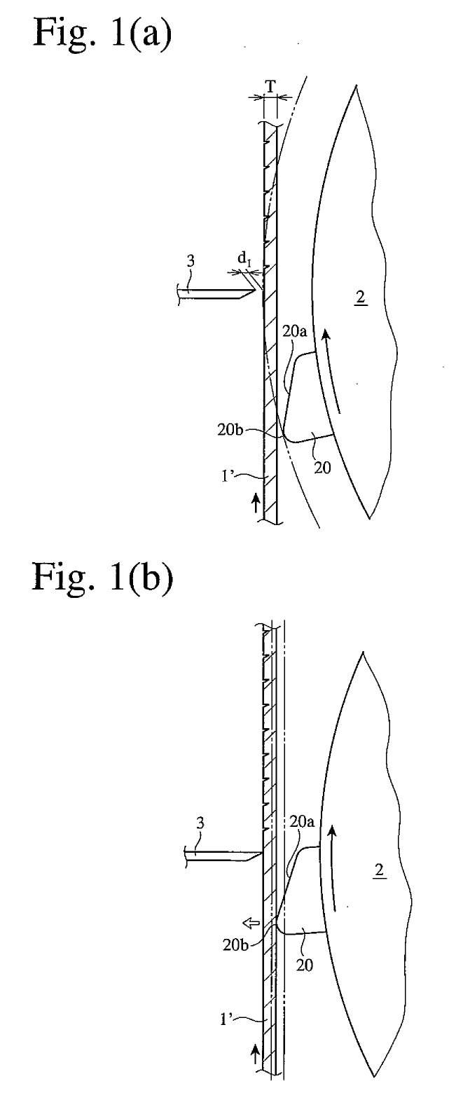

As shown in FIG. 1(a), a rotatable roll 2 having pluralities of cams 20 and a cutter 3 are arranged with a narrower gap than the thickness of a long plastic film 1′. A gap d₁ between the cam 20 and the cutter 3 is preferably 10-50% of the thickness T of a plastic film 1′. An angle θ₁ of the cutter 3 to the plastic film 1′ is preferably 90±10° , more preferably 90±5° . An edge angle θ₂ of the cutter 3 is preferably 30-45° .

The cam 20 comprises a front surface portion 20a slanting rearward relative to the radius of the roll 2, and a round top end 20b closest to the cutter 3. With this structure, the plastic film 1′ is not cut apart when the cam 20 comes to contact with the plastic film 1′. The plastic film 1′ moves preferably in the same direction as the rotation direction of the roll. To form sharp half-cut lines 10, a ratio of the peripheral speed Vr of the roll 2 to the moving speed Vf of the plastic film 1′ is preferably 10-50, more preferably 20-40. Of course, the range of Vr/Vf is not restricted, and its upper limit, for instance, may be larger if the production speed is sacrificed. To obtain such a Vr/Vf ratio, the moving speed Vf of the plastic film 1′ is preferably 10-500 m/minute, more preferably 10-300 m/minute. The rotation speed of the roll 2 is preferably 1,000-4,000 rpm, for instance, when the diameter of the roll 2 is 20-300 mm.

As shown in FIGS. 1(a) to 1(d), the cam 20 is separate from the plastic film 1′ at a position where it is separate from the cutter 3, but as the cam 20 nears the cutter 3, it pushes the plastic film 1′ to the cutter 3. At the closest position shown in FIG. 1(c), the plastic film 1′ is provided with half-cut lines 10.

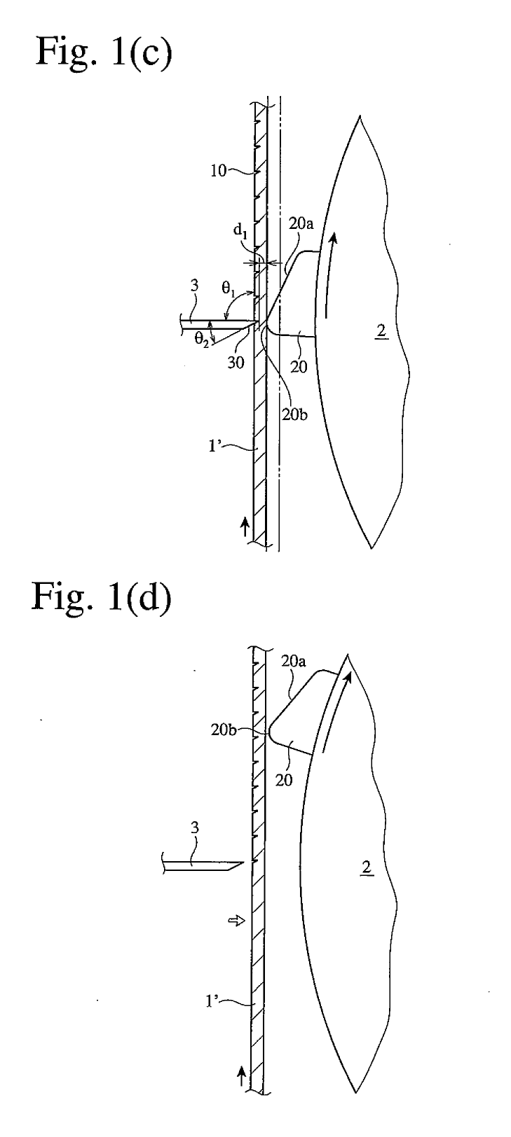

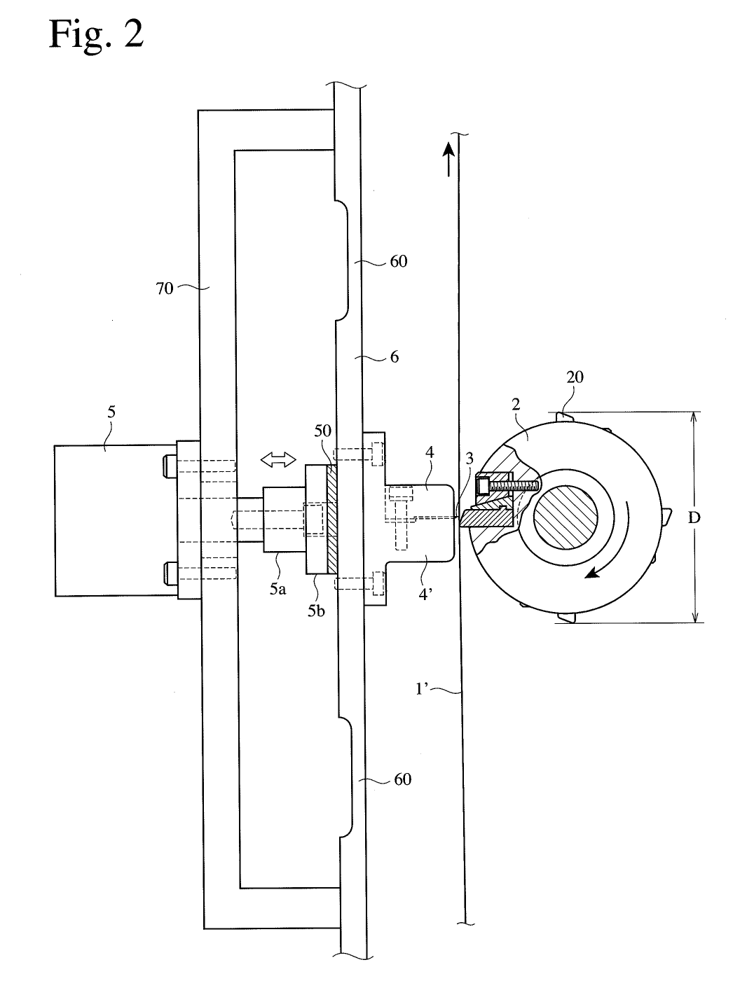

As shown in FIGS. 2 and 3, the rotational shaft of the roll 2 is set in parallel to the transverse direction of the plastic film 1′. The roll 2 is longer than the width of the plastic film 1′, so that the plastic film 1′ in its entire width comes to contact with the cam 20 of the roll 2. The diameter D of the roll 2 is, for instance, 2-30 cm. The number of cams 20 mounted to the roll 2 is preferably 4 or more for productivity, though changeable depending on the diameter D of the roll 2.

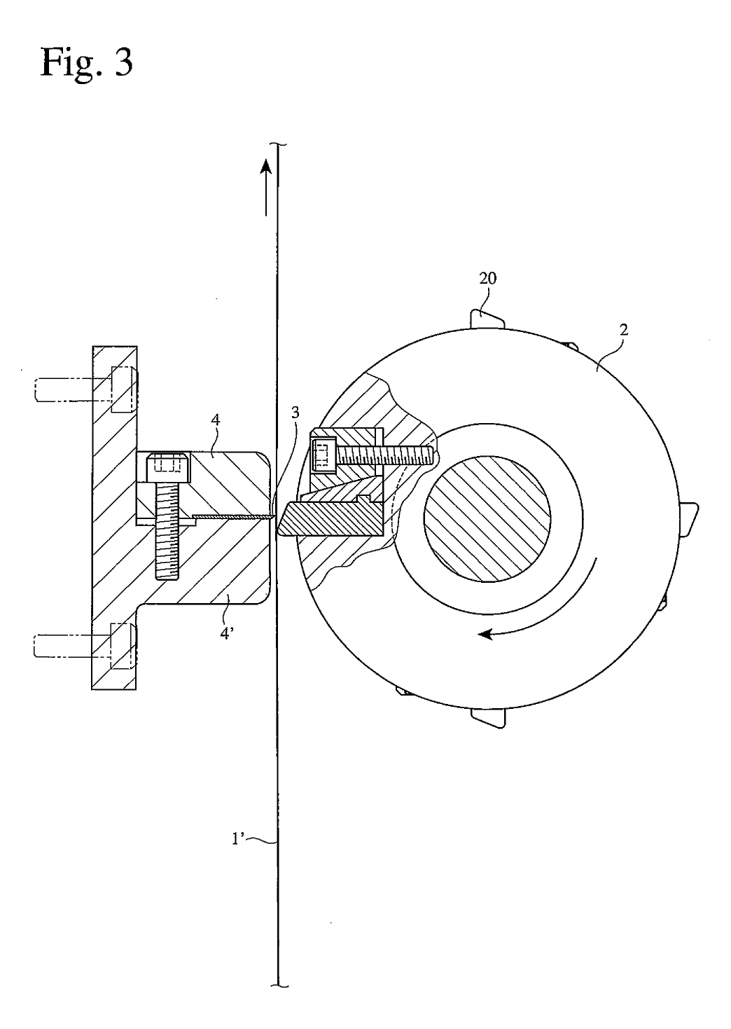

Although the cams 20 may be integral with the roll 2, they are preferably detachable as shown in FIG. 4. In this case, the cam body 20′ has a ridge 20a having a rectangular cross section on one surface, a wedge member 21 engaging the cam body 20′ has a groove 21a for receiving the ridge 20a and a slanting surface 21b, and a nut member 22 engaging the wedge member 21 has a slanting surface 22a complimentary to the slanting surface 21b of the wedge member 21. The cam body 20′, the wedge member 21 and the nut member 22 are received in a groove 120 of the roll 2. When a bolt 23 threadably engages a threaded hole 120a of the roll 2 via the nut member 22, the cam body 20′ is pushed by the nut member 22 via the wedge member 21, so that two surfaces of the cam body 20′ are strongly abutted to two surfaces 120a and 120b of the groove 120, resulting in precise positioning of the cam body 20′.

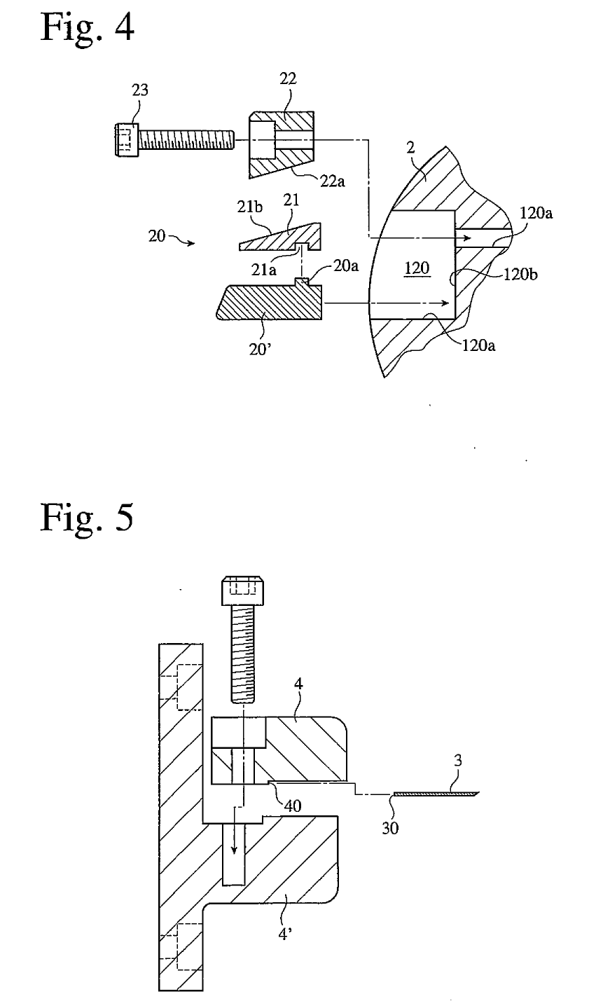

As shown in FIGS. 2 and 3, holders 4, 4′ for fixing the cutter 3 are fixed to a resilient metal plate 6 mounted to a frame 70 of the apparatus. The resilient metal plate 6 may have a resiliently deformable thin portion 60 around a position at which the holders 4, 4′ are mounted. The frame 70 is provided with a actuator 5 such as an air or hydraulic cylinder. A pressing means 5b is mounted to a tip end of a shaft 5a of the actuator 5, and a buffer plate 50 made of rubber, etc. is attached to a surface of the pressing means 5b. As shown in FIG. 5, the holders 4, 4′ for fixing the cutter 3 are combined by screws, one holder piece 4 being provided with a step 40 to which an end 30 of the cutter 3 abuts.

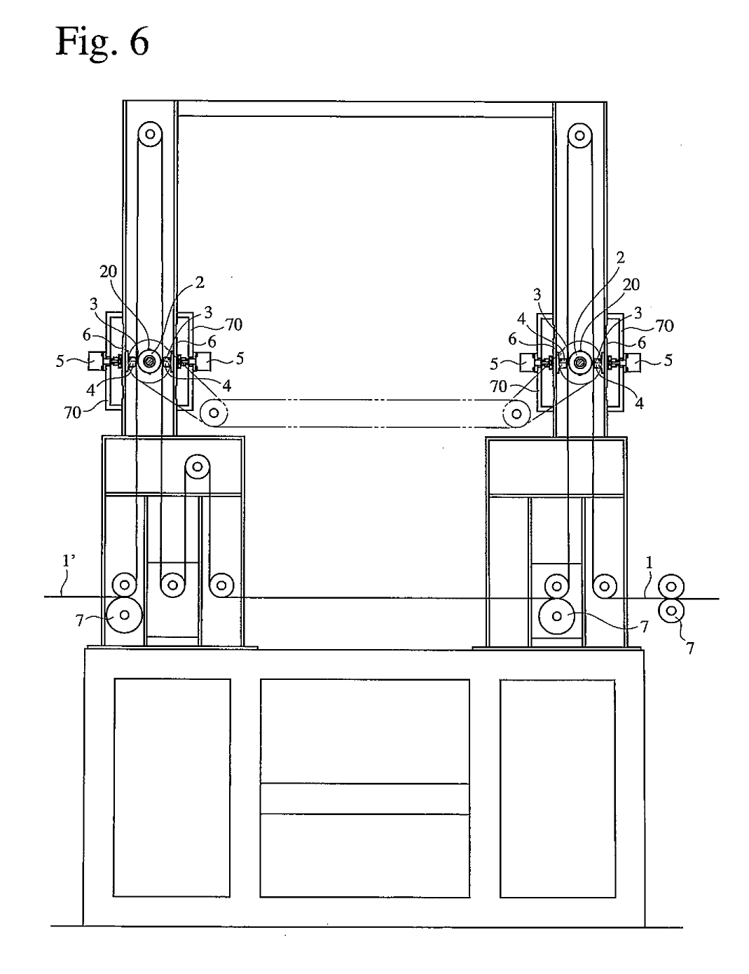

FIG. 6 shows an apparatus for producing an easy-to-straight-tear plastic film according to one embodiment of the present invention. This apparatus has two stations for forming half-cut lines along the moving plastic film 1′. In each station for forming half-cut lines, cutters 3, 3 are arranged on both sides of the roll 2 having cams 20. Each cutter 3 and the roll 2 having cams 20 are in the above-described positional relation.

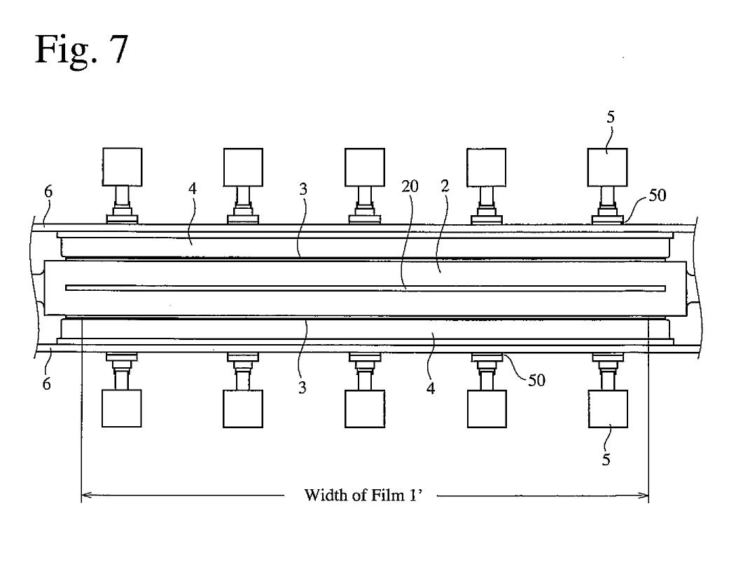

In a preferred embodiment of the present invention, as shown in FIG. 7, pluralities of actuators 5 are arranged along the roll 2 with substantially equal intervals. Because a plastic film 1′ on which half-cut lines are formed by the present invention usually has a thickness of about 10-40 μm, the depth of half-cut lines should be controlled with precision of several micron meters. However, it is extremely difficult to control a gap between the roll 2 and the cutter 3 with precision of several micron meters over the entire length of about 1 m of the roll 2 and the cutter 3. Thus used is extremely small resilient deformation of the resilient metal plate 6, to which the holders 4, 4′ of the cutter 3 are fixed, obtained by pushing the resilient metal plate 6 by the actuator 5, so that the position of the cutter 3 can be controlled with precision of several micron meters. The thin portion 60 makes it possible to cause the parallel movement of the resilient metal plate 6 with a relatively small pushing force, thereby providing more precise position control of the cutter 3. To secure high positional precision of the cutter 3, the resilient metal plate 6 is preferably as thick as possible. For instance, the resilient metal plate 6 is as thick as about 1 cm, and the thin portion 60 has about half thickness thereof.

In the case of a cutter 3 of about 1 m, for instance, because it is difficult to have a uniform gap between the cutter 3 and the cam 20 along their length, pluralities of actuators 5 should be provided. Though not restrictive, the intervals of the actuators 5 may be about 10-30 cm. The operation of individual actuators 5 should be controlled such that the cutter 3 and the cam 20 have the same gap over their length.

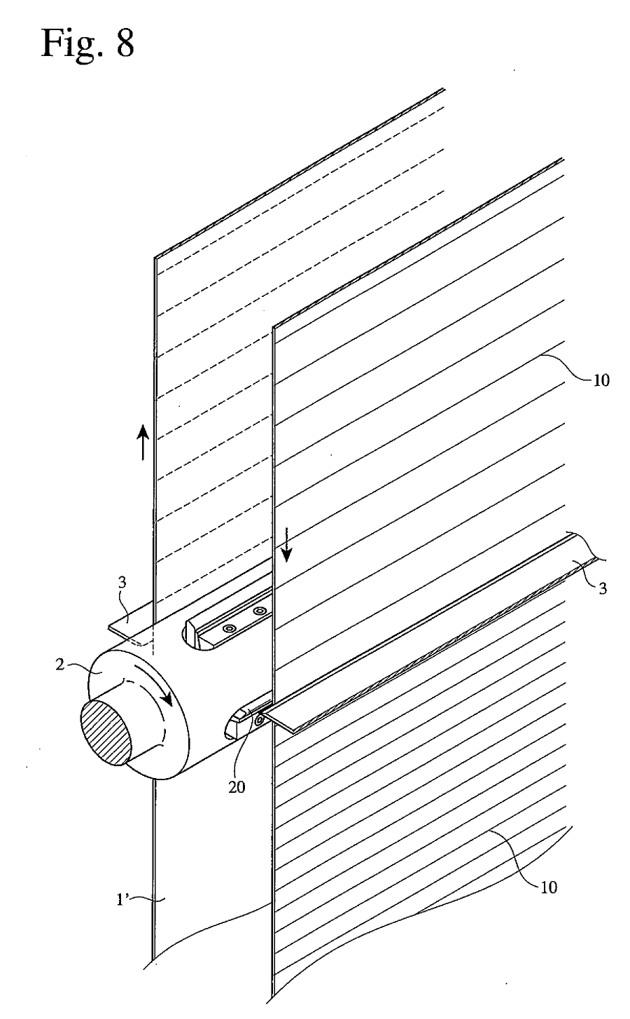

In the apparatus shown in FIG. 6, the plastic film 1′ passes two stations for forming half-cut lines with tension given by pluralities of nip rolls. The tension per width given by the nip roll 7 to the plastic film 1′ is, for instance, 0.5-10 kgf/m. Because there are cutters 3, 3 on both sides of the roll 2 in each station for forming half-cut lines, as shown in FIG. 8, half-cut lines 10 are formed two times on the plastic film 1′. Because half-cut lines 10 are formed four times in the entire apparatus, a finished, easy-to-straight-tear plastic film has extremely large numbers of half-cut lines 10.

The interval d (mm) of half-cut lines 10, the moving speed Vf (mm/minute) of the plastic film 1′, the rotation speed Vt (rpm) of the roll 2, the number n of rolls 2, the number m of cams 20 in each roll 2, and the number p of cutters 3 per one roll 2 meet the relation of d×n×m×p=Vf/Vt. In the apparatus shown in FIG. 6, for instance, the interval d of half-cut lines 10 is 1 mm when the rotation speed Vt of both rolls 2, 2 is 2,000 rpm, and the moving speed Vf of the plastic film 1′ is 32 m/minute.

The peripheral speed of the roll 2 is preferably 10-50 times the moving speed of the plastic film 1′. As shown in FIG. 1(c), because the plastic film 1′ is moving even while the cutter 3 bites the plastic film 1′, the width of each half-cut line 10 is slightly larger than the thickness of the cutter 3. Namely, the half-cut lines 10 are slightly expanded by the cutter 3. The above ratio within 10-50 times provides the minimum difference between the width of the half-cut lines 10 and the thickness of the cutter 3, thereby avoiding the unevenness of the half-cut lines 10 and the breakage of the plastic film 1′.

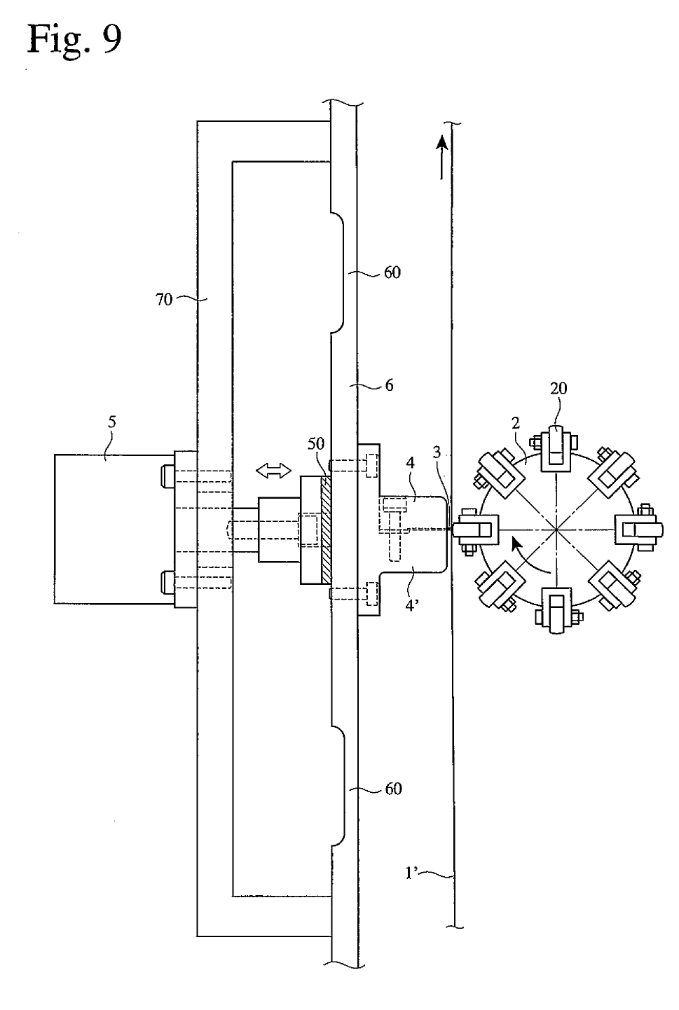

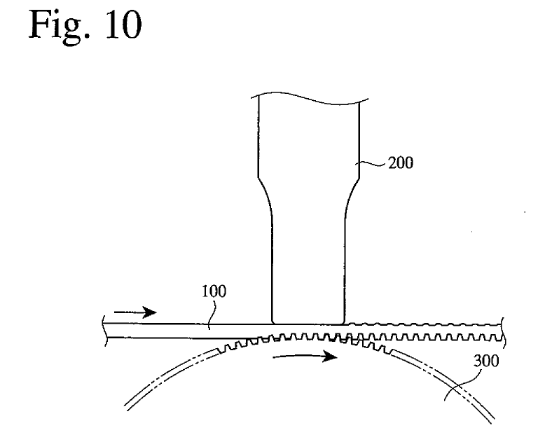

FIG. 9 shows the apparatus for producing an easy-to-straight-tear plastic film according to another embodiment of the present invention. This apparatus is the same as shown in FIG. 2, except that a roll 2 is provided with eight cams 20 each having a curved tip surface.

[2] Plastic Film

The plastic film 1′ is made of, for instance, polyesters, polyarylene sulfide(polyphenylene sulfide, etc.), polyamides, polyimides, polyamideimides, polyethersulfones, polyetheretherketones, polycarbonates, acrylic resins, polystyrenes, ABS resins, fluororesins, polyolefins(polyethylene, polypropylene, etc.), polyvinyl chlorides, etc. The plastic film 1′ may have large numbers of fine pores. The fine pores preferably have an average opening diameter of 0.5-100 μm and an average density of about 500/cm² or more. The fine pores may be formed by the method described in Japanese Patent 2063411.

[3] Easy-To-Straight-Tear Plastic Film

Because the long, easy-to-straight-tear plastic film 1 of the present invention obtained by the above method has large numbers of substantially parallel half-cut lines 10 extending in a transverse direction on at least one surface, it can be torn substantially straight from an arbitrary position. The half-cut lines 10 are preferably formed on the entire surface of the plastic film. To have high strength and straight tearability, the depth of the half-cut lines 10 is preferably 10-50% of the thickness of the easy-to-straight-tear plastic film 1.

Although the present invention has been explained above referring to the attached drawings, the present invention is not restricted thereto but may be modified unless changing its concept.

### EFFECTS OF THE INVENTION

In the present invention, a plastic film moves in a gap narrower than the thickness of the plastic film between a roll having cams and a cutter, so that the cams can intermittently push the plastic film to the cutter by the rotation of the roll, to form large numbers of parallel half-cut lines on the plastic film without dust. The easy-to-straight-tear plastic film thus obtained can be torn substantially straight from an arbitrary position.

The easy-to-straight-tear plastic film of the present invention may be used for various wrapping bags for foods, medicines, lunch boxes, etc. Because wrappings of the easy-to-straight-tear plastic film can be torn straight from any positions, there is no inconvenience at all to open them. In addition, because mass-produced wrapping bags are generally heat-sealed in a transverse direction of a long plastic film, the use of the easy-to-straight-tear plastic film of the present invention having half-cut lines in a transverse direction makes it easy to open wrapping bags in parallel to heat seals. Also, the use of the easy-to-straight-tear plastic film of the present invention makes it unnecessary to attach tapes for providing opening width to wrapping bags.

1. A long, easy-to-straight-tear plastic film having large numbers of substantially parallel half-cut lines extending in a transverse direction on at least one surface.

2. The easy-to-straight-tear plastic film according to claim 1, wherein said half-cut lines are formed over the entire surface.

3. The easy-to-straight-tear plastic film according to claim 1, wherein the depth of said half-cut lines is 10-50% of the thickness of said plastic film.

4. A method for producing a long, easy-to-straight-tear plastic film having large numbers of substantially parallel half-cut lines extending in a transverse direction on at least one surface, comprising the steps of (1) arranging a roll having at least one cam axially extending on a circular surface of said roll, and a cutter parallel to said roll, with a gap narrower than the thickness of said plastic film, (2) moving said plastic film between said roll and said cutter in a direction perpendicular to the axial direction of said roll, and (3) rotating said roll so that said cam intermittently pushes said plastic film to said cutter to form half-cut lines on said plastic film.

5. The method for producing an easy-to-straight-tear plastic film according to claim 4, wherein a gap between said cam and said cutter is 10-50% of the thickness of said plastic film.

6. The method for producing an easy-to-straight-tear plastic film according to claim 4, wherein said half-cut lines are formed on an entire surface of said plastic film.

7. The method for producing an easy-to-straight-tear plastic film according to claim 4, wherein said roll has pluralities of cams with substantially equal intervals.

8. The method for producing an easy-to-straight-tear plastic film according to claim 4, wherein the peripheral speed of said roll is 10-50 times the moving speed of said plastic film.

9. An apparatus for producing a long, easy-to-straight-tear plastic film having large numbers of substantially parallel half-cut lines extending in a transverse direction on at least one surface, comprising (a) a roll having at least one cam axially extending on a circular surface of said roll, and (b) a cutter arranged in parallel to said roll with a gap narrower than the thickness of said plastic film, said plastic film moving between said roll and said cutter in a direction perpendicular to the axial direction of said roll, the rotation of said roll causing said cam to intermittently push said plastic film to said cutter to form half-cut lines on said plastic film.

10. The apparatus for producing an easy-to-straight-tear plastic film according to claim 9, wherein a gap between said cam and said cutter is 10-50% of the thickness of said plastic film.

11. The apparatus for producing an easy-to-straight-tear plastic film according to claim 9, wherein said roll has pluralities of cams with substantially equal intervals.

12. The apparatus for producing an easy-to-straight-tear plastic film according to claim 9, wherein a holder of said cutter is fixed to a resilient plate mounted to a frame of the apparatus, wherein said holder engages pluralities of actuators fixed to said frame along said roll, and wherein when said actuators are operated to press said holder, said resilient plate is resiliently deformed by a pressing force to finely adjust the position of said cutter fixed to said holder, such that a gap between said cam and said cutter is substantially uniform over the entire width of said plastic film.

13. The apparatus for producing an easy-to-straight-tear plastic film according to claim 9, wherein a holder of said cutter is fixed to a resilient plate mounted to a frame of the apparatus, wherein said holder engages pluralities of actuators fixed to said frame along said roll, and wherein when said actuators are operated to press said holder, said resilient plate is resiliently deformed by a pressing force to finely adjust the position of said cutter fixed to said holder, such that a gap between said cam and said cutter is substantially uniform over the entire width of said plastic film.

14. The apparatus for producing an easy-to-straight-tear plastic film according to claim 13, wherein said resilient plate has a resiliently deformable thin portion.
